(19) United States
(12) Patent Application Publication
(10) Pub. No.: US 2009/0055498 A1
(43) Pub. Date: Feb. 26, 2009

(54) Administration Of Time-Sensitive Email

(75) Inventor: Joe N. Brown, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/843,273

(22) Filed: Aug. 22, 2007

(51) Int. Cl. G06F 15/16

(52) U.S. Cl. 709/207

(57) ABSTRACT

Administration of time-sensitive email including receiving, by a recipient email module from a sender email module, identifying, by the recipient email module, the time to open the time-sensitive email message; notifying, by the recipient email module, a user of the time to open the time sensitive email message; receiving, by the recipient email module, from the user an alternative time to open; sending, by the recipient email module to the sender email module, the alternative time to open; agreeing, by the sender email module, to the alternative time to open; and in response to the agreement to the alternative time to open, receiving, by the recipient email module from the sender email module, a passcode to display the time-sensitive email message.

### BACKGROUND OF THE INVENTION

1. Field of the Invention

The field of the invention is data processing, or, more specifically, methods, apparatus, and products for administration of time-sensitive email.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Users of computers today often communicate with one another through electronic means such as electronic mail. Email messages are often sent with information that is time-sensitive. Typical email clients have no capability to control the presentation of such time-sensitive information included in an email message. Typical email clients may present time-sensitive information at a time other than that intended by the sender.

### SUMMARY OF THE INVENTION

Methods, apparatus, and product for administration of time-sensitive email are disclosed that include receiving, by a recipient email module from a sender email module, identifying, by the recipient email module, the time to open the time-sensitive email message; notifying, by the recipient email module, a user of the time to open the time sensitive email message; receiving, by the recipient email module, from the user an alternative time to open; sending, by the recipient email module to the sender email module, the alternative time to open; agreeing, by the sender email module, to the alternative time to open; and in response to the agreement to the alternative time to open, receiving, by the recipient email module from the sender email module, a passcode to display the time-sensitive email message.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for administration of time-sensitive email according to embodiments of the present invention.

FIG. 2 sets forth a block diagram of automated computing machinery comprising an exemplary computer useful in administration of time-sensitive email according to embodiments of the present invention.

FIG. 3 sets forth a flow chart illustrating an exemplary method for administration of time-sensitive email according to embodiments of the present invention.

FIG. 4 sets forth a flow chart illustrating a further exemplary method for administration of time-sensitive email according to embodiments of the present invention.

### DETAILED DESCRIPTION OF EXEMPLARY EMBODIMENTS

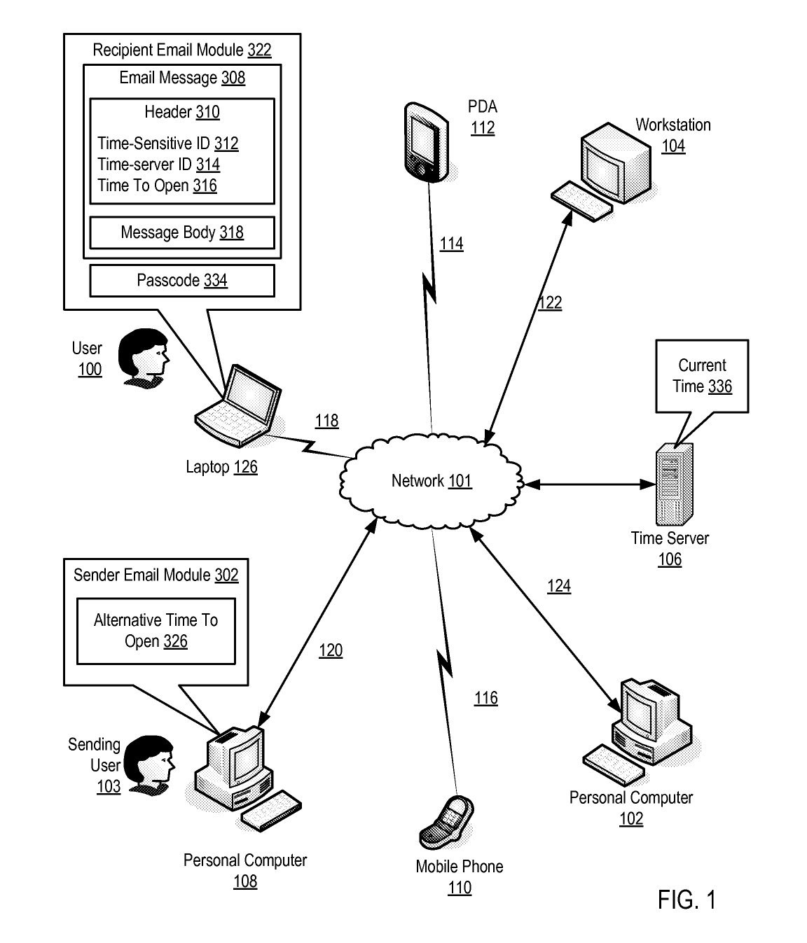

Exemplary methods, apparatus, and products for administration of time-sensitive email in accordance with the present invention are described with reference to the accompanying drawings, beginning with FIG. 1. FIG. 1 sets forth a network diagram of a system for administration of time-sensitive email according to embodiments of the present invention. The system of FIG. 1 is capable of receiving, by a recipient email module (322) from a sender email module (302), identifying, by the recipient email module (322), the time to open (316) the time-sensitive email message (308); notifying, by the recipient email module (322), a user (100) of the time to open (316); receiving, by the recipient email module (322), from the user (100) an alternative time to open (326); sending, by the recipient email module (322) to the sender email module (302), the alternative time to open (326); agreeing, by the sender email module (302), to the alternative time to open (326); and in response to the agreement to the alternative time to open (326), receiving, by the recipient email module (322) from the sender email module (302), a passcode (334) to display the time-sensitive email message (308).

A time-sensitive email message is an email message that cannot be opened unless the current time conforms to a time to open the email message, specified by the sender. A recipient email module retrieves from a time server identified in the header of the time-sensitive email message, the current time to determine whether the current time conforms to the time to open.

In the system of FIG. 1 the exemplary time-sensitive email message (308) includes a header (310) and a message body (318). The header (310) of the exemplary time-sensitive email message (308) of FIG. 1 includes an identification (312) of the email message as a time-sensitive email message, an identification (314) of a time-server (106), and a time to open (316) the email message (308).

The system of FIG. 1 includes a sender email module (302) and a recipient email module (322). A sender email module is a module of computer program instructions that is capable of creating email messages and transmitting email messages. The email module is so called a ‘sender’ email module for clarity because the sender email module according to embodiments of the present invention operates generally for sending and not for receiving email messages.

A recipient email module (322) is a module of computer program instructions that is capable of receiving time-sensitive email messages and displaying the message body of time-sensitive email message to the recipient user. The email application is so called a ‘recipient’ email application for clarity because the recipient email module according to embodiments of the present invention operates generally for receiving and not for sending email messages.

Although the sender and recipient email modules of FIG. 1 are shown as separate module operating on physically distinct computing machinery, readers of skill in the art will immediately recognize that a time-sensitive email client application according to embodiments of present invention may include both a recipient email module and the sender email module. In this specification, the recipient and sender email modules will be described as separate modules for clarity.

The exemplary recipient email module (322) is shown in the system of FIG. 1 as operating on the laptop (126) which is coupled for data communications to the network (101) by wireless connection (118). The recipient email module (322) may, however, operate on any automated computing machinery. The system of FIG. 1 includes many devices on which the recipient email module (322) may operate including, for example:
a personal digital assistant (‘PDA’) (112) which is coupled for data communications to the network (101) by wireless connection (114);
a workstation (104) which is coupled for data communications to the network (101) by wireline connection (122);
a mobile phone (110) which is coupled for data communications to the network (101) by wireless connection (116); and
a personal computer (102) which is coupled for data communications to the network (101) by wireless connection (124).

In a similar manner, although shown in FIG. 1 as operating on the personal computer (108) which is coupled for data communications to the network (101) through wireline connection (120), the sender email module (302) may operate any the above mentioned devices.

The system of FIG. 1 also includes a time server (106). A time server is a server that reads the current time (336) from a reference clock and distributes this information to clients through a computer network. A time server may be a local network time server or an internet time server. The time reference used by a time server could be another time server on the network or the Internet, a connected radio clock or an atomic clock. The most common true time source is a Global Position System (‘GPS’) master clock.

The most widely-used protocol for distributing and synchronizing time is the Network Time Protocol (‘NTP’). The Network Time Protocol (NTP) is a protocol for synchronizing computer clocks over packet-switched, variable-latency data networks. NTP uses User Datagram Protocol (‘UDP’) port 123 as its transport layer. NTP is designed to resist the effects of variable latency or jitter.

The arrangement of servers and other devices making up the exemplary system illustrated in FIG. 1 are for explanation, not for limitation. Data processing systems useful according to various embodiments of the present invention may include additional servers, routers, or other devices, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

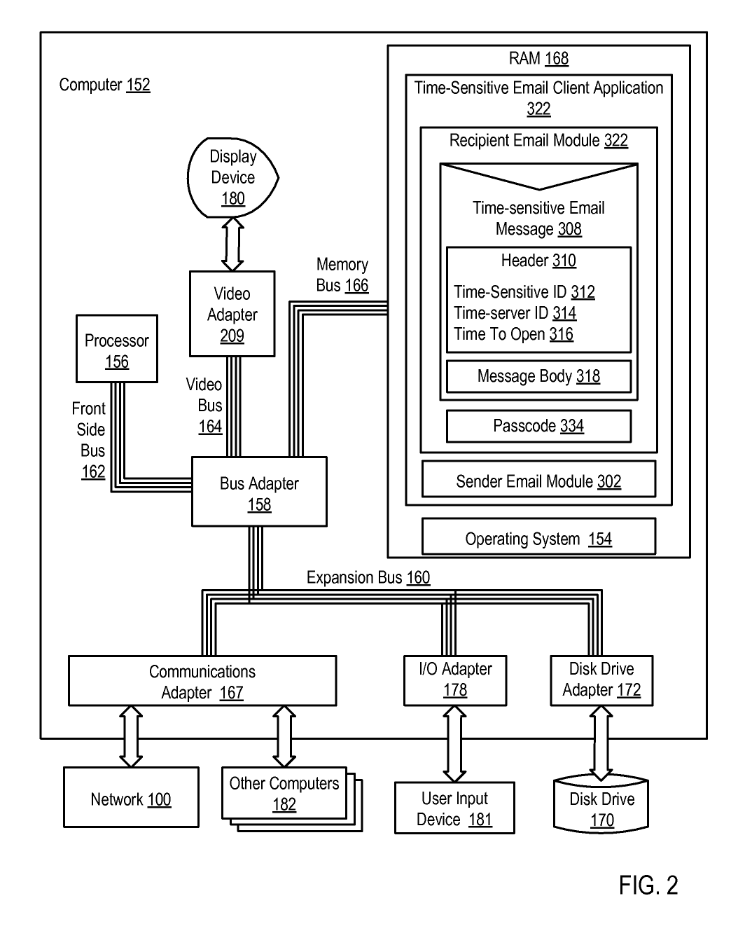

Administration of time-sensitive email in accordance with the present invention is generally implemented with computers, that is, with automated computing machinery. In the system of FIG. 1, for example, the time server (106), personal computer (108) and laptop (126), are implemented to some extent at least as computers. For further explanation, therefore, FIG. 2 sets forth a block diagram of automated computing machinery comprising an exemplary computer (152) useful in administration of time-sensitive email according to embodiments of the present invention. The computer (152) of FIG. 2 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a time-sensitive email client application (322). As mentioned above, a time-sensitive email client application (210) may be configured with both a sender and recipient email module. The time-sensitive email client application (210) of FIG. 2 includes a recipient email module (322), a module of computer program instructions useful in administration of time-sensitive email in accordance with the present invention. The exemplary recipient email module (332) of FIG. 2 is capable of receiving, from a sender email module, a time-sensitive email message (308); identifying the time to open (316) the time-sensitive email message (308); notifying, a user of the time to open (316); receiving from the user an alternative time to open; sending, to the sender email module, the alternative time to open; and in response to an agreement to the alternative time to open, receiving, from the sender email module, a passcode (334) to display the time-sensitive email message (308).

In the system of FIG. 2, the exemplary time-sensitive email message (308) includes a header (310) and a message body (318). The header (310) of the time sensitive email message (308) of FIG. 2 includes an identification (312) of the email message as a time-sensitive email message, an identification (314) of a time-server, and a time to open (316) the email message (308).

Also stored in RAM (168) is an operating system (154). Operating systems useful administration of time-sensitive email according to embodiments of the present invention include UNIX™, Linux™, Microsoft XP™, AIX™, IBM's i5/OS™, and others as will occur to those of skill in the art. The operating system (154) and recipient email module (322) in the example of FIG. 2 are shown in RAM (168), but many components of such software typically are stored in non-volatile memory also, such as, for example, on a disk drive (170).

The computer (152) of FIG. 2 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for administration of time-sensitive email according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 2 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 2 includes a communications adapter (167) for data communications with other computers (182) and for data communications with a data communications network (100). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for administration of time-sensitive email according to embodiments of the present invention include modems for wired dial-up communications, Ethernet (IEEE 802.3) adapters for wired data communications network communications, and 802.11 adapters for wireless data communications network communications.

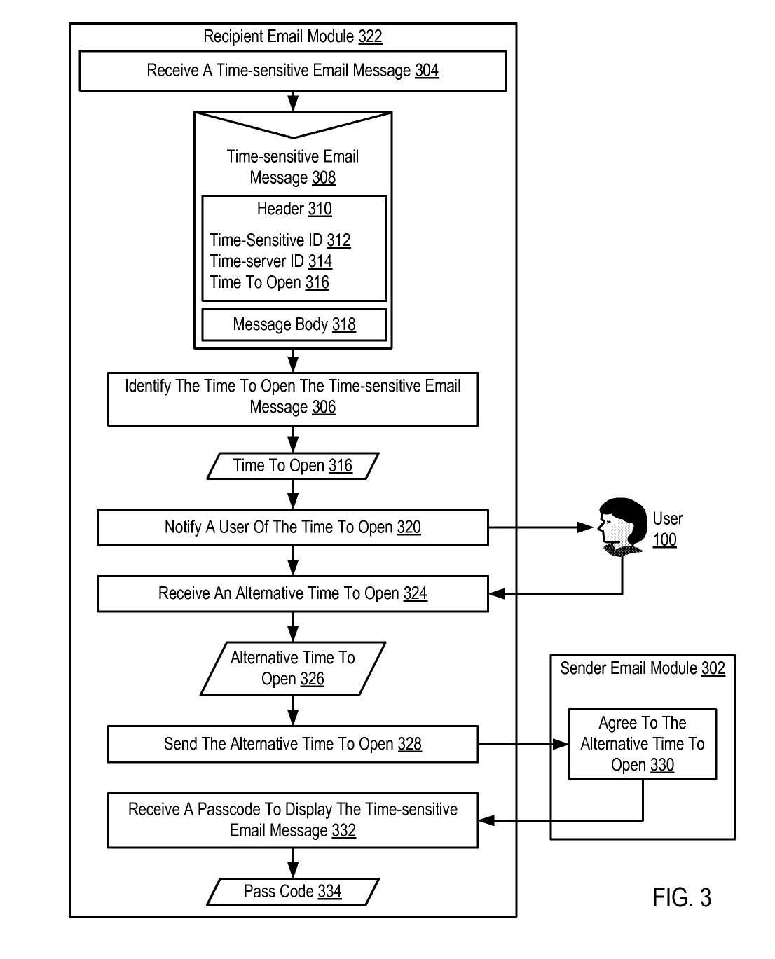

For further explanation, FIG. 3 sets forth a flow chart illustrating an exemplary method for administration of time-sensitive email according to embodiments of the present invention. The method of FIG. 3 includes receiving (304), by a recipient email module (322) from a sender email module (302), a time-sensitive email message (308). As mentioned above, a recipient email module (322) is a module of computer program instructions that is capable of receiving time-sensitive email messages and displaying the message body of time-sensitive email message to the recipient user. Also as mentioned above, a sender email module (302) is a module of computer program instructions that is capable of creating email messages and transmitting email messages.

As mentioned above, a time-sensitive email message is an email message that cannot be opened unless the current time conforms to a time to open the email message, specified by the sender. A recipient email module retrieves from a time server identified in the header of the time-sensitive email message, the current time to determine whether the current time conforms to the time to open.

Typical email message include a header as well as a message body. A typical header of an email message may include any of the following fields:
A ‘from’ field that identifies the email address, and optionally the name, of the sender of the message.
A ‘to’ field that identifies one or more email addresses, and optionally one or more names, of the receivers of the message.
A ‘subject’ field that includes a brief summary of the contents of the message body.
A ‘date’ field that identifies the local time and date that the message sent.
Others as will occur to those of skill in the art.

In addition to the common fields in a typical header of an email message, the header of the exemplary time-sensitive email of FIG. 3 also includes an identification (312) of the email message as a time-sensitive email message, an identification (314) of a time-server, and a time to open (316) the email message (308).

For further explanation, consider the following exemplary header of a time-sensitive email message according to embodiments of the present invention:
From: MarySmith@example.com
To: JohnSmith@example.com
Subject: Winter Product Line
Date: Aug. 8, 2007
Email ID: Time-sensitive
Lower Time Constraint: 11-1-2007 6:01 UTC
Time Server ID: 0.pool.ntp.org

In the example above, the email header includes a ‘From’ field that identifies the email address of the sender of the email message. The email address of the sender of the message is MarySmith@example.com. In the example above, the email header includes a ‘To’ field that identifies the email address of the intended recipient of the email message. The email address of the intended recipient of the email message is JohnSmith@example.com.

In the example above, the email header includes a ‘Subject’ field that includes a brief summary of the contents of the message body. The brief summary of the contents of the message body in this example is “Winter Product Line.” In the example above, the email header includes a ‘Date’ field that identifies the local time and date that the message was sent. The local time and date that the message was sent is Aug. 8, 2007. In the example above, the email header includes an ‘Email ID field’ that identifies whether the email message is a time-sensitive email message or a time-independent email message. In the example above, the email message is identified as a time-sensitive email message.

In the example above, the email header includes a ‘Lower Time Constraint’ field that identifies a time to open the email message. The time to open is a lower time constraint, the first time at which the recipient may open the email. The time to open the email message is 6:01 UTC on Nov. 1, 2007. The email message cannot be opened by the recipient until Nov. 1, 2007 at 6:01 UTC.

The time to open in this example is expressed in terms of UTC, Coordinated Universal Time. UTC is a high-precision atomic time standard. Time zones around the world are expressed as positive or negative offsets from UTC. Local time is UTC plus the time zone offset for that location, plus an offset for daylight saving time, if necessary. UTC is often also referred to as Zulu time. The current time provided by Network Tim Protocol (‘NTP’) servers is typically expressed in UTC. Although the above example shows the time to open as expressed in terms in UTC for clarity, readers of skill in the art will recognize that the time to open could also be expressed in terms of the senders local time or the recipients local time and later converted to UTC to determine whether the current time retrieved from the time server conforms to the time to open. Alternatively, the current time retrieved from the time server may be converted to local time represented in the time to open in the header of the time-sensitive email message.

A time server is a server that reads the current, actual time from a reference clock and distributes this information to clients through a computer network. A time server may be a local network time server or an internet time server. In the example above, the email header includes a ‘Time Server ID’ that identifies the time server that the recipient email module uses to determine whether the current time conforms to the time to open. The recipient email module must use the identification 0.pool.ntp.org to retrieve the current time.

In the above example, the time to open is expressed in terms of a lower time constraint. A time to open is the time at which the recipient email module will allow a user of the recipient email module to view the message body of the time-sensitive email message. A time to open may include dates, days of the week, hours, minutes, seconds, and other unit of time as will occur to those of skill in the art. A time to open may be expressed as a ‘do not open before’ time, a ‘do not open after time,’ or as a combination of the two. A recipient email module will not allow a user to view the message body of a time-sensitive email having a time to open that is a do not open before time until the current time is greater than the do not open before time. Alternatively a recipient email module will allow a user to view the message body of a time-sensitive email having a time to open that is a do not open after time only as long as the current time is less than the do not open before time. The do not open before time is therefore a lower time constraint and the do not open after time is an upper time constraint. A combination of a do not open before and a do not open after time is a window of time in which the message body of the email may be displayed to a user.

Continuing with the above exemplary header, if the time to open is a combination of a do not open before and do not open after time, the exemplary header may recite:
From: MarySmith@example.com
To: JohnSmith@example.com
Subject: Winter Product Line
Date: Aug. 8, 2007
Email ID: Time-sensitive
Time Server ID: 0.pool.ntp.org
Lower Time Constraint: 11-1-2007 6:01 UTC
Upper Time Constraint: 11-2-2007 6:01 UTC

In the example above, the email header includes, in addition to a “Lower Time Constraint,” an “Upper Time Constraint” that identifies the time at which the recipient email program may no longer open the email message. The window of time for a recipient email program to open the email message, in this example, is between Nov. 1, 2007 at 6:01 UTC and Nov. 2, 2007 at 6:01 UTC.

The method of FIG. 3 also includes identifying (306), by the recipient email module (322), the time to open (316) the time-sensitive email message (308). Identifying (306), by the recipient email module (322), the time to open (316) the time-sensitive email message (308) may be carried out by parsing, by the recipient email module, the header of the email message and discovering fields for a lower time constraint, an upper time constraint, or both.

The method of FIG. 3 also includes notifying (320), by the recipient email module (322), a user (100) of the time to open (316). Notifying a user may include displaying the time to open to the user as well as other information describing the time-sensitive email message such as, for example, the subject of the time-sensitive email message, the email address or name of the sender, or the email address or name of other recipients of the email message.

The method of FIG. 3 also includes receiving (324), by the recipient email module (322), from the user (100) an alternative time to open (326). The user may provide an alternative time to open (326) through a Graphical User Interface (‘GUI’) provided by recipient email module for such purpose.

The method of FIG. 3 also includes sending (328), by the recipient email module (322) to the sender email module (302), the alternative time to open (326). Sending (328), by the recipient email module (322) to the sender email module (302), the alternative time to open (326) may be carried out by sending the alternative time to open in a time-independent email message, a time-sensitive email message, or through any other means as will occur to those of skill in the art. The recipient email module may, for example, send the alternative time to open in a time-sensitive email having a ‘do not open after’ time in order to limit the time in which the sender may agree to the alternative time to open.

The method of FIG. 3 also includes agreeing (330), by the sender email module (302), to the alternative time to open (326). Agreeing (330) to the alternative time to open (326) may include determining, by the sender email module, whether the user is a member of a pre-configured class of recipients. Determining, by the sender email module (302), whether the user is a member of a pre-configured class of recipients may be carried out in various ways such as, for example, determining whether the user's email address, name, or Internet Protocol address is on a list of members of the pre-configured class.

If the user is a member of the pre-configured class of recipients, then the sender email module agrees to the alternative time to open. In this way a sending user may use the pre-configured class to automatically agree to any alternative time to open from those members of the pre-configured class. Consider as an example, a time-sensitive email sent by a sending user to a number of recipients including the sending user's boss and a number of other co-workers. If the sending user has a pre-configured class of recipients that includes the sending user's boss, the sender email module will automatically agree to any alternative time to open proposed by the sending user's boss.

If, however, the user is not a member of the pre-configured class of recipients, the sender email module notifies a sending user of the alternative time to open, and receives, from the sending user, a user agreement to the alternative time to open. Continuing with the above example, if a recipient co-worker that is not a member of the pre-configured class proposes an alternative time to open, the sender email module notifies the sending user and the sending user may choose whether to agree to the alternative time to open.

In response to the agreement (330) to the alternative time to open (326), the method of FIG. 3 continues by receiving (332), by the recipient email module (322) from the sender email module (302), a passcode (334) to display the time-sensitive email message (308). A passcode is any data element that can be used to open a time-sensitive email message including, for example, a password.

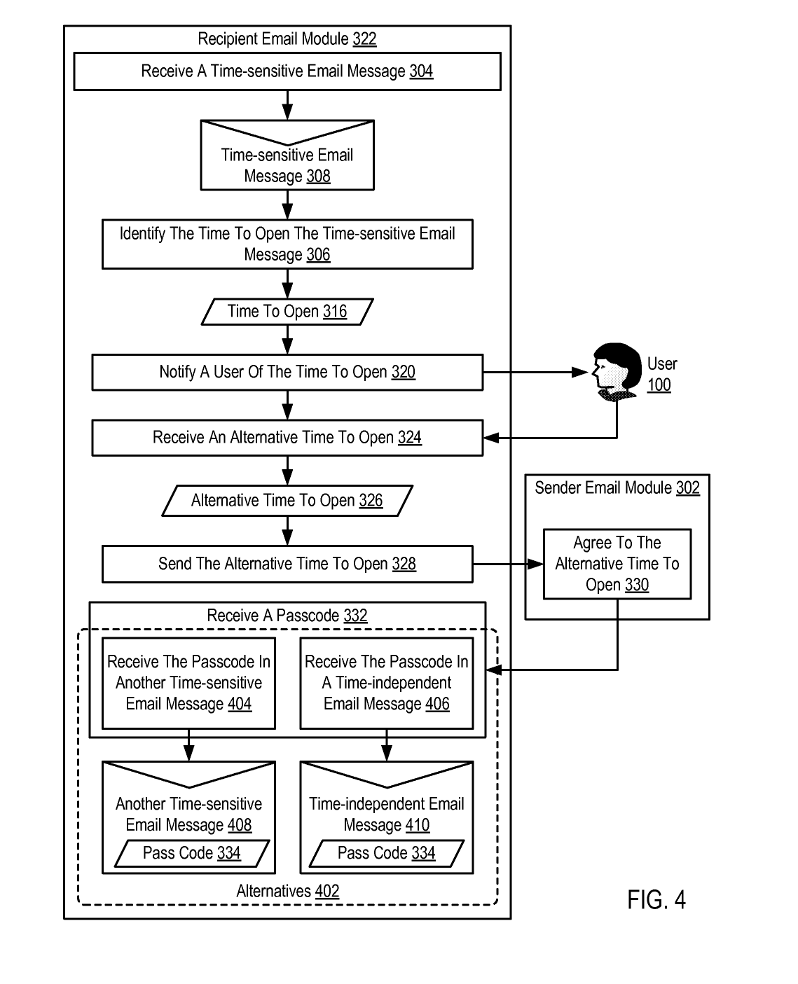

Receiving (332) a passcode (334) to display the time-sensitive email message (308) may be carried out in various ways. For further explanation, therefore, FIG. 4 sets forth a flow chart illustrating a further exemplary method for administration of time-sensitive email according to embodiments of the present invention that includes two alterative (402) methods for receiving (332) a passcode (332). The method of FIG. 4 is similar to the method of FIG. 3 in that the method of FIG. 4 includes receiving (304), by a recipient email module (322) from a sender email module (302), a time-sensitive email message (308), identifying (306), by the recipient email module (322), the time to open (316) the time-sensitive email message (308); notifying (320), by the recipient email module (322), a user (100) of the time to open (316); receiving (324), by the recipient email module (322), from the user (100) an alternative time to open (326); sending (328), by the recipient email module (322) to the sender email module (302), the alternative time to open (326); agreeing (330), by the sender email module (302), to the alternative time to open (326); and in response to the agreement (330) to the alternative time to open (326), receiving (332), by the recipient email module (322) from the sender email module (302), a passcode (334) to display the time-sensitive email message (308).

The method of FIG. 4 differs from the method of FIG. 3, however, in that the method of FIG. 4 includes two alternative (402) methods of receiving (332) a passcode (334). In the method of FIG. 4, one alternative (402) method of receiving (332) a passcode (334) to display the time-sensitive email message (308) is receiving (404) the passcode (334) in another time-sensitive email message (408).

A time-sensitive email message (408) having a passcode (334) may have as its time to open, the alternative time to open. That is, the passcode in the time-sensitive email message (408) is not accessible until the agreed on, alternative time to open (326). The alternative time to open therefore may be a lower time constraint that is lower than the original time constraint specified by the original time to open, but still greater than the current time. If the original time to open is a lower time constraint of 10 days from today, for example, and the alternative time to open is a lower time constraint of 7 days from today, sending a passcode alone will allow the recipient email module to open the time-sensitive email even before the alternative time to open. Sending the passcode in a time-sensitive email having a lower time constraint of 7 days from today, however, ensures that the passcode, and therefore the original time-sensitive email, cannot be accessed until the alternative time to open.

If however, the alternative time to open (326) is on or before the current time, there is a second, alternative (402) method of receiving (332) a passcode (334) to display the time-sensitive email message (308). Receiving (332) a passcode (334) to display the time-sensitive email message (308) may also be carried out, for example, by receiving (406) the passcode (334) in a time-independent email message (410). That is, immediately upon receiving the time-independent email message, a recipient may open the time-independent email message, access the passcode in the time-independent email message, and use the passcode to open the time-sensitive email message (308).

Exemplary embodiments of the present invention are described largely in the context of a fully functional computer system for administration of time-sensitive email. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for administration of time-sensitive email, the method comprising:
receiving, by a recipient email module from a sender email module, a time-sensitive email message, the time-sensitive email message comprising a header and a message body, the header comprising an identification of the email message as a time-sensitive email message, an identification of a time-server, and a time to open the email message;
identifying, by the recipient email module, the time to open the time-sensitive email message;
notifying, by the recipient email module, a user of the time to open the time-sensitive email message;
receiving, by the recipient email module, from the user an alternative time to open;
sending, by the recipient email module to the sender email module, the alternative time to open;
agreeing, by the sender email module, to the alternative time to open; and
in response to the agreement to the alternative time to open, receiving, by the recipient email module from the sender email module, a passcode to display the time-sensitive email message.

2. The method of claim 1 wherein receiving a passcode to display the time-sensitive email message further comprises receiving the passcode in another time-sensitive email message.

3. The method of claim 1 wherein receiving a passcode to display the time-sensitive email message further comprises receiving the passcode in a time-independent email message.

4. The method of claim 1 wherein agreeing to the alternative time to open further comprises:
determining, by the sender email module, whether the user is a member of a pre-configured class of recipients; and
in response to determining that the user is a member of the pre-configured class of recipients, agreeing, by the sender email module, to the alternative time to open.

5. The method of claim 4 further comprising:
in response to determining that is not a member of the pre-configured class of recipients, notifying, by the sender email module, a sending user of the alternative time to open; and
receiving, from the sending user, a user agreement to the alternative time to open.

6. The method of claim 1 wherein the time to open the time-sensitive email message is a do not open before time.

7. The method of claim 1 wherein the time to open the time-sensitive email message is a do not open after time.

8. An apparatus for administration of time-sensitive email, the apparatus comprising a computer processor, a computer memory operatively coupled to the computer processor, the computer memory having disposed within it computer program instructions capable of:
receiving, by a recipient email module from a sender email module, a time-sensitive email message, the time-sensitive email message comprising a header and a message body, the header comprising an identification of the email message as a time-sensitive email message, an identification of a time-server, and a time to open the email message;
identifying, by the recipient email module, the time to open the time-sensitive email message;
notifying, by the recipient email module, a user of the time to open the time sensitive email message;
receiving, by the recipient email module, from the user an alternative time to open;
sending, by the recipient email module to the sender email module, the alternative time to open;
agreeing, by the sender email module, to the alternative time to open; and
in response to the agreement to the alternative time to open, receiving, by the recipient email module from the sender email module, a passcode to display the time-sensitive email message.

9. The apparatus of claim 8 wherein receiving a passcode to display the time-sensitive email message further comprises receiving the passcode in another time-sensitive email message.

10. The apparatus of claim 8 wherein receiving a passcode to display the time-sensitive email message further comprises receiving the passcode in a time-independent email message.

11. The apparatus of claim 8 wherein agreeing to the alternative time to open further comprises:
determining, by the sender email module, whether the user is a member of a pre-configured class of recipients; and
in response to determining that the user is a member of the pre-configured class of recipients, agreeing, by the sender email module, to the alternative time to open.

12. The apparatus of claim 11 further comprising computer program instructions capable of:
in response to determining that the user is not a member of the pre-configured class of recipients, notifying, by the sender email module, a sending user of the alternative time to open; and
receiving, from the sending user, a user agreement to the alternative time to open.

13. The apparatus of claim 8 wherein the time to open the time-sensitive email message is a do not open before time.

14. The apparatus of claim 8 wherein the time to open the time-sensitive email message is a do not open after time.

15. A computer program product for administration of time-sensitive email, the computer program product disposed in a computer readable, signal bearing medium, the computer program product comprising computer program instructions capable of:
receiving, by a recipient email module from a sender email module, a time-sensitive email message, the time-sensitive email message comprising a header and a message body, the header comprising an identification of the email message as a time-sensitive email message, an identification of a time-server, and a time to open the email message;
identifying, by the recipient email module, the time to open the time-sensitive email message;
notifying, by the recipient email module, a user of the time to open the time sensitive email message;
receiving, by the recipient email module, from the user an alternative time to open;
sending, by the recipient email module to the sender email module, the alternative time to open;
agreeing, by the sender email module, to the alternative time to open; and
in response to the agreement to the alternative time to open, receiving, by the recipient email module from the sender email module, a passcode to display the time-sensitive email message.

16. The computer program product of claim 15 wherein receiving a passcode to display the time-sensitive email message further comprises receiving the passcode in another time-sensitive email message.

17. The computer program product of claim 15 wherein receiving a passcode to display the time-sensitive email message further comprises receiving the passcode in a time-independent email message.

18. The computer program product of claim 15 wherein agreeing to the alternative time to open further comprises:
determining, by the sender email module, whether the user is a member of a pre-configured class of recipients; and
in response to determining that the user is a member of the pre-configured class of recipients, agreeing, by the sender email module, to the alternative time to open.

19. The computer program product of claim 15 wherein the signal bearing medium comprises a recordable medium.

20. The computer program product of claim 15 wherein the signal bearing medium comprises a transmission medium.
